(19) United States
(12) Patent Application Publication
(10) Pub. No.: US 2013/0109467 A1
(43) Pub. Date: May 2, 2013

(54) TRANSACTION METHOD AND A METHOD OF CONTROLLING USE OF A GAME

(71) Applicant: Aristocrat Technologies Australia Pty Limited, North Ryde (AU)

(72) Inventors: Nick Graham Roach, Wentworth Falls (AU); Michael Thomas McNee, Cammeray (AU); David James Greenslade, Queens Park (AU)

(73) Assignee: Aristocrat Technologies Australia Pty Limited, North Ryde (AU)

(21) Appl. No.: 13/724,336

(22) Filed: Dec. 21, 2012

Related U.S. Application Data
(63) Continuation of application No. 12/561,598, filed on Sep. 17, 2009, now abandoned.

(30) Foreign Application Priority Data
Sep. 19, 2008 (AU) 2008904895

(51) Int. Cl. G07F 17/32

(52) U.S. Cl. CPC G07F 17/32
USPC 463/29

(57) ABSTRACT

In an example, a gaming device includes a license module, the license module arranged to determine, prior to allowing execution of program code of a game having an associated license, whether the license is a fixed term license or a continual term license, and, if the license is a fixed term license, check that the license is current before allowing the program code to execute. In an example, a method of controlling use of a game by a gaming device, the game having an associated license, includes determining prior to allowing the program code of the game to execute whether the license is a fixed term license or a continual term license, and, if the license is a fixed term license, checking whether the license is current before allowing the program code to execute.

### CROSS-REFERENCE TO RELATED APPLICATIONS

The present application claims the benefit of priority to U.S. patent application Ser. No. 12/561,598, filed on Sep. 17, 2009, entitled “A TRANSACTION METHOD AND A METHOD OF CONTROLLING USE OF A GAMING,” and Australian Provisional Patent Application No. 2008904895, filed on Sep. 19, 2008, entitled “A TRANSACTION METHOD AND A METHOD OF CONTROLLING USE OF A GAME”, both of which are herein incorporated by reference in their entireties.

### FIELD

The invention relates to a transaction method and a method of controlling use of a game.

### BACKGROUND

In many markets gaming machines have traditionally been sold for an up front fee. This sales model is potentially unsatisfactory for both parties to the transaction. For the purchaser, they run the risk that the gaming machine will not be sufficiently popular and hence not provide an adequate return on investment. On the other hand, the seller can be a victim of their own success because when a game is highly successful it does not need to be replaced. In addition, the sales model brings with it an inherent reluctance of the purchaser to replace even moderately successful games because of the risk that that the replacement game will not live up to the same standard. As a result, there is a tendency for the rate of turnover of games to stagnate, reducing the attractiveness of the purchaser's venue and the number of machines the seller can sell.

Accordingly, there is a need for an alternative sales model. It would be advantageous, if the sales model were, at least to some extent, compatible with the existing sales model or at least presented alternatives. Further, there is a need for techniques to monitor such a system.

### SUMMARY

In a first aspect, the invention provides a transaction method including:

selling for a first value, a game to be implemented by a gaming device; and

selling for a second value, a license to use the game on a gaming device.

In an embodiment, the transaction method includes selling the game by selling a game kit including game code and media bearing artwork to be applied to the gaming device.

In an embodiment, the transaction method includes providing the game code on a memory device.

In an embodiment, the memory device is an EPROM.

In an embodiment, wherein the license is a continual term license which entitles the licensee to use the game for an unlimited time but precludes the licensee from purchasing and associating a replacement game with the license.

In an embodiment, the licensee is entitled to associate a replacement game with the license if the replacement game is provided under a warranty.

In an embodiment, the license is a fixed term license which entitles the licensee to use the game for a fixed time and allows the licensee to associate a purchased replacement game with the license.

In an embodiment, the transaction method includes selling at least one replacement game for a third value.

In an embodiment, a base value of the third value is the same as a base value of the first value.

In an embodiment, the transaction method includes:

offering a choice between
a continual term license which entitles the licensee to use the game for an unlimited time but precludes the licensee from purchasing and associating a replacement game with the license, and
a fixed term license which entitles the licensee to use the game for a fixed time and allows the licensee to associate a purchased replacement game with the license; and

receiving a selection of one a continual term license and a fixed term license,

and wherein selling a license includes selling the selected license.

In an embodiment, the transaction method includes offering a loyalty discount based on the percentage of the total number of gaming devices that are subject of a fixed license.

In an embodiment, the total number of gaming devices is derived from at least one of a total number of gaming devices owned by the purchaser and a total number of gaming devices deployed at a venue controlled by the purchaser.

In a second aspect, the invention provides a method of controlling use of at least one game, the method including:

selling for a first value, a game to be implemented by a gaming device;

selling for a second value, a license to use the game on a gaming device, the license having a term; and

permitting the game to be used on a gaming device while the term is current.

In an embodiment, the transaction method includes:

offering a choice between
a continual term license which entitles the licensee to use the game for an unlimited time but precludes the licensee from purchasing and associating a replacement game with the license, and
a fixed term license which entitles the licensee to use the game for a fixed time and allows the licensee to associate a purchased replacement game with the license; and

receiving a selection of one of a continual term license and a fixed term license,

and wherein selling a license includes selling the selected license.

In an embodiment, the transaction method includes determining prior to allowing the program code of the game to execute whether the license is a fixed term license or a continual term license, and, if the license is a fixed term license, checking whether the license is current before allowing the program code to execute.

In an embodiment, the transaction method includes preventing the game from being used after the term of a fixed term license.

In an embodiment, the transaction method includes making a record in a data structure of the license and the game with which it is associated.

In an embodiment, the transaction method includes: receiving a request from a licensee of the license to associate a further game purchased by the licensee with the license during the term of the license; and

denying the request if the license is a continual term license; or

allowing the request if the license is a fixed term license.

In an embodiment, the transaction method includes making a record in a data structure of the license and the game with which it is associated and checking the data structure in response to receipt of the request.

In a third aspect, the invention provides a method of licensing a plurality of games, including:
issuing a fixed term license to a licensee;
associating the fixed term license with a first game purchased by the licensee such that the first game can be used on a gaming device; and
transferring the issued fixed term license to a second game purchased by the licensee such that the second game can be used on the gaming device.

In an embodiment, the transaction method includes allowing the licensee to successively associate as many game as desired with the fixed term license during the term of the fixed term license.

In an embodiment, the transaction method includes recording the association in a data structure, periodically checking the data structure to determine whether the fixed term license is still current or has expired.

In an embodiment, the transaction method includes preventing further use of a game currently associated with the fixed term license when the fixed term license is determined to have expired.

In a fourth aspect, the invention provides a method of controlling use of a game by a gaming device, the game having an associated license, the method including determining prior to allowing the program code of the game to execute whether the license is a fixed term license or a continual term license, and, if the license is a fixed term license, checking whether the license is current before allowing the program code to execute.

In an embodiment, the transaction method includes checking a record in a data structure to determine whether the license is current.

In an embodiment, the checking is performed by a license module of a gaming device and includes checking whether a dongle connected to the gaming device has a record in a data structure indicative that the license is current.

In an embodiment, checking is performed by a license module of a gaming device including checking a data structure in data communication with the gaming device over a network to determine whether the data structure has a record indicative that the license is current.

In a fifth aspect, the invention provides a gaming device including a license module, the license module arranged to determine, prior to allowing execution of program code of a game having an associated license, whether the license is a fixed term license or a continual term license, and, if the license is a fixed term license, check that the license is current before allowing the program code to execute.

In an embodiment, the license module checks whether a dongle connected to the gaming device which stores a data structure has a record in the data structure indicative that the license is current.

In a sixth aspect, the invention provides a gaming system including:

a communication network;

a data structure storing records indicative of whether a game has an associated license, whether each license is a continual license or a fixed term license, and when a term of each fixed term license expires; and

at least one gaming device connected to the data structure via the communication network, and arranged to determine by checking the data structure, prior to allowing execution of program code of a game having an associated license, whether the license is a fixed term license or a continual term license, and, if the license is a fixed term license, that the license is current before allowing the program code to execute.

The invention also provides for, computer program code which when executed implements the above method, a tangible computer readable medium including the computer program code, transmitting the computer program code of and a data signal including the computer program code.

### BRIEF DESCRIPTION OF DRAWINGS

Certain exemplary embodiments of the invention will now be described with reference to the accompanying drawings in which:

FIG. 1 is a block diagram of a gaming system of an embodiment;

FIG. 2 is a perspective view of a stand alone gaming machine;

FIG. 3 is a block diagram of the functional components of a gaming machine;

FIG. 4 is a schematic diagram of the functional components of a memory;

FIG. 5 is a block diagram of a gaming device of an embodiment;

FIG. 6 is a block diagram of a gaming device of another embodiment;

FIG. 7 is a flow chart of an embodiment;

FIG. 8 is a further flow chart.

Features, further aspects, and advantages of the present invention will become apparent from the following description of embodiments thereof, by way of example only, with reference to the accompanying drawings. Also, various embodiments of the aspects described in the preceding paragraphs will be apparent from the appended claims, the following description and/or the accompanying drawings. It should be understood, however, that the present invention is not limited to the arrangements and instrumentality shown in the attached drawings.

### DETAILED DESCRIPTION

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended apparatus claims are read to cover a purely software and/or firmware implementation, in at least one embodiment, at least one of the elements is hereby expressly defined to include a tangible medium such as a memory, DVD, CD, etc. storing the software and/or firmware.

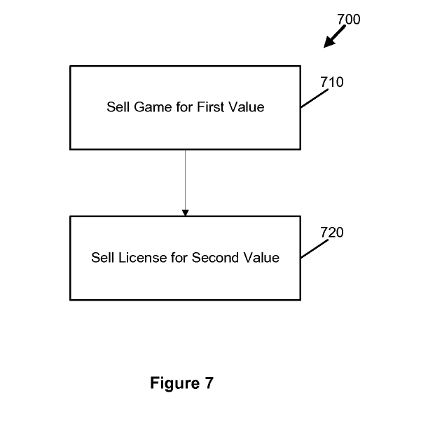

Referring to the drawings and in particular to FIG. 7, there is shown a transaction method 700 where games are sold 710 separately to licenses 720 to use the games. In each transaction a game is sold for a first value and the license is sold for a second value. The game is typically distributed as a game kit including a memory device, such as an EPROM storing the game code which can be inserted into a main board of a gaming device by a technician and art work which can be applied to the gaming device. The art work is provided on media such as paper or a laminate to allow it to be applied to the housing of the gaming device. Many gaming devices incorporate specific areas which are adapted to removeably receive appropriate artwork.

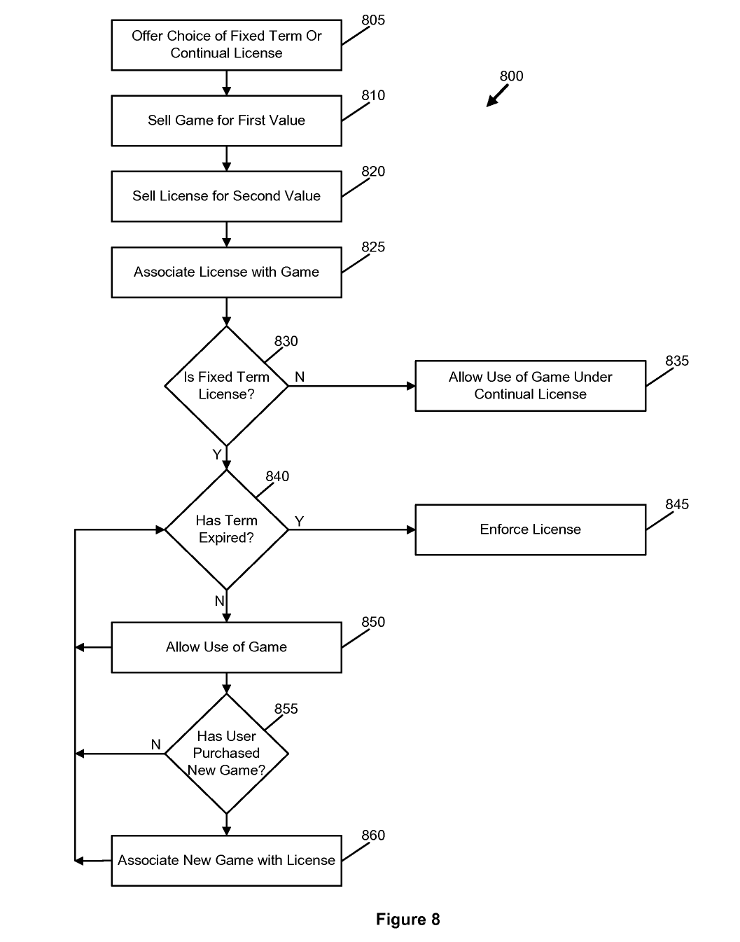

In the embodiment of FIG. 8, the method 800 involves offering 805 two types of license: a continual term license and a fixed term license (for example 2 or 3 years). A game is sold 810 for a first value and a license is sold 820 for a second value. The license is then associated 825 with a game. In the embodiment, this is achieved by creating a record for the license in a data structure and storing an identification of the game against the license. In the embodiment, discounts of the base value of the first and second values are provided based on the number of fixed term licenses held/purchased by the licensee. For example based on the total number of license owned by the purchaser or the total number of licenses deployed at a venue controlled by the purchaser.

In the embodiment, a continual term license entitles the licensee to use the game associated with the license for as long as they desire, however, a replacement game can only be associated with the license if it is replaced under warranty. In contrast, a fixed term license entitles the user to purchase a replacement game and associate it with the license. Thus, the method involves periodically checking to determine whether the fixed term license has expired. In the exemplary embodiment of FIG. 8, this involves checking 830 for fixed term licenses in the data structure. Where a continual license is associated with a game, the term for use 835 of the game is open ended. An advantage of offering this type of license in addition to fixed term licenses is that it provides purchasers a choice which closely mimics the current sales model such that those purchasers who do not want to take advantage of the fixed term licenses of the embodiment do not feel inappropriately constrained.

When a fixed term license is in place, the method of the embodiment of FIG. 8 involves determining 840 whether the license has expired. If the license has expired, the method involves enforcing the license which can be achieved in a number of different ways as described below. If the fixed term license has not expired use of the game is allowed 850. If the user purchases a new game 855, the game can be associated 860 with the existing license.

Accordingly, it will be appreciated that from time to time requests will be received from purchasers of new game kits to associate the purchased game kit with an existing license. The method involves allowing the request if the license is a fixed term license (which is current) and denying the license if the license is a continual license.

Benefits of the fixed term licenses under the above transaction method include:
Greater Freedom to manage the floor
   Lower game kit prices
   Reduced change over costs
   Reduced restrictions
Improved Player Entertainment
   Access to all the latest games
   The ability to purchase more of the better games to use in shorter periods of time
Improved Floor Yield management
   The option to take more product risks to increase performance
   The option to Purchase more of the top performing games in the venue
   Expenditure focus is on games and not hardware
   Player's can always find a seat on the best game in the venue

Neither type of license is transferrable independently of the business which purchases it and a secondary license must be purchased by another party to operate the game.

### Gaming System

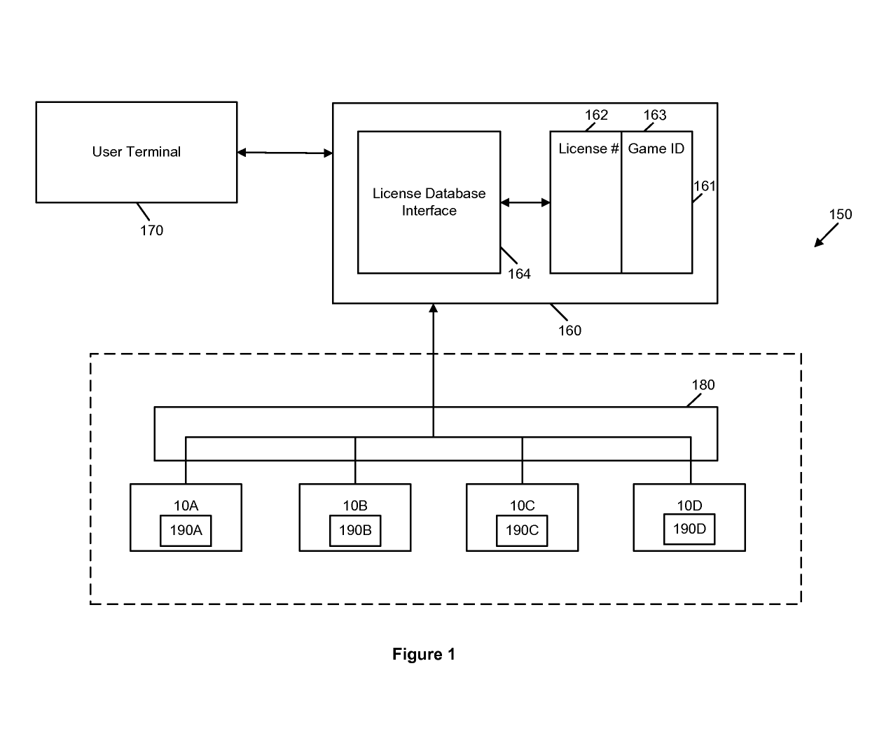

FIG. 1 shows an exemplary gaming system 150 for implementing the above embodiment. When a license is sold, a user operates a user terminal 170 to access license database interface 164 to record the license and the game with which it is associated in license database 161 stored in a license controller 160, which may be implemented on a computer server (for example). It will be apparent license database 161 provides a data structure which has a license record 162 with which is associated a game ID 163. The license record 162 also stores the name of the licensee, whether the licenses are continual or fixed term license and if the license is a fixed term license, the term of the fixed term. Persons skilled in the art will appreciate that the license database interface 164 may be arranged to receive data for entry into the database 161 in other manners. For example, the license database interface could be connected by a web interface to a purchasing mechanism where a user makes their own purchases and associates licenses and games such that the need for a user terminal 170 is obviated.

FIG. 1 illustrates two possible ways in which the licenses can be checked and enforced. In a first method, the user periodically operates user terminal to access the database 161 and by sorting the database, which could be for example an Excel spreadsheet, determines which licenses have expired since the last check and the games associated with them. The user can then contact the licensee that hold the licenses—e.g. to ask them to renew the license or in order to take action to revoke the license.

Persons skilled in the art will appreciate that the manual checking of whether the license has expired can be replaced by the license database interface 164 being configured to automatically present a list to a user of the licenses that have expired. Alternatively, the license database interface 164 can be arranged to automatically communicate license expiry messages to the licensee, for example by e-mail.

FIG. 1 also illustrates an additional or alternative license checking method which involves connecting individual gaming machines 10A to 10D to the licensing controller 160 over a network 180. In this embodiment each gaming machine 10 includes a licensing module 190 which is configured to contact the licensing controller 160 periodically to determine whether the license associated with the game running on the gaming machine 10 is still current. In this embodiment, the license database interface 164 is configured to deal with requests from the licensing modules 190, query the database 161 and return a result to the licensing module 190 over network 180 to enable the licensing module 190 to determine whether it has a current license. In this embodiment, the licensing modules 190 may be operable, for example, to prevent a boot sequence of the gaming machine 10 occurring or to switch the gaming machine 10 off in a manner that does not affect the rights of any person playing the gaming machine.

### General Construction of Gaming Device

Gaming devices on which games can be executed can take a number of different forms including server based gaming devices but will typically be provided in the form of a stand alone gaming machine.

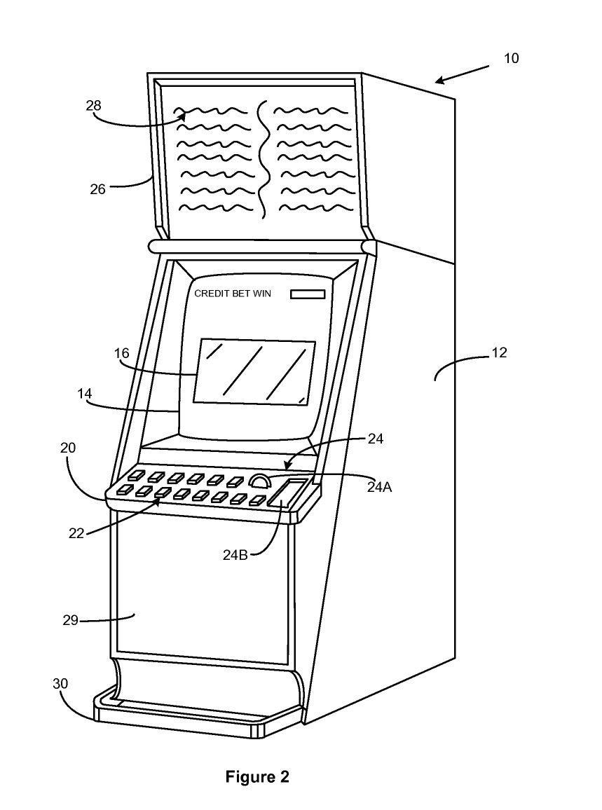

A gaming device in the form of a stand alone gaming machine 10 is illustrated in FIG. 2. The gaming machine 10 includes a console 12 having a display 14 on which are displayed representations of a game 16 that can be played by a player. A mid-trim 20 of the gaming machine 10 houses a bank of buttons 22 for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. A player marketing module (not shown) having a reading device may also be provided for the purpose of reading a player tracking device, for example as part of a loyalty program. The player tracking device may be in the form of a card, flash drive or any other portable storage medium capable of being read by the reading device.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 2 is in the form of a video display unit, particularly a cathode ray tube screen device. Alternatively, the display 14 may be a liquid crystal display, plasma screen, any other suitable video display unit, or the visible portion of an electromechanical device. The top box 26 may also include a display, for example a video display unit, which may be of the same type as the display 14, or of a different type.

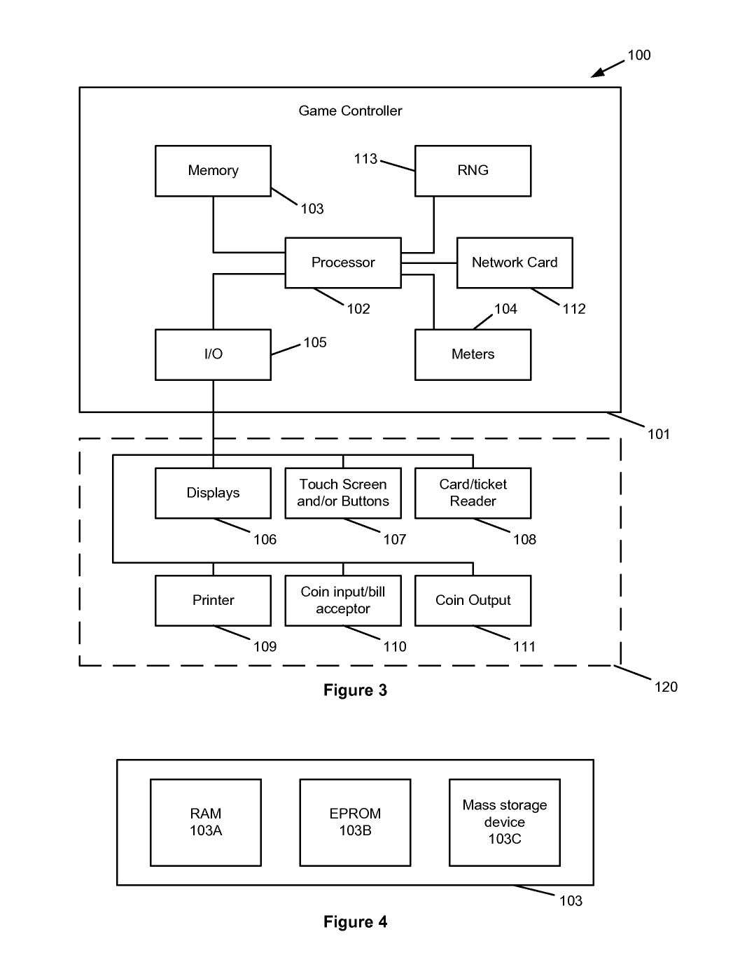

FIG. 3 shows a block diagram of operative components of a typical gaming machine which may be the same as or different to the gaming machine of FIG. 2.

The gaming machine 100 includes a game controller 101 having a processor 102. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 including one or more displays 106, input devices in the form of a touch screen and/or buttons 107 (which provide a game play mechanism), a card and/or ticket reader 108, a printer 109, a bill acceptor and/or coin input mechanism 110 and a coin output mechanism 111. Additional hardware may be included as part of the gaming machine 100, or hardware may be omitted based on the specific implementation.

In addition, the gaming machine 100 may include a communications interface, for example a network card 112. The network card may, for example, send status information, accounting information or other information to a central controller, server or database and receive data or commands from the central controller, server or database.

FIG. 4 shows a block diagram of the main components of an exemplary memory 103. The memory 103 may include, for example, RAM 103A, EPROM 103B and a mass storage device 103C. The RAM 103A typically temporarily holds program files for execution by the processor 102 and related data. The EPROM 103B may be a boot ROM device and/or may contain some system or game related code. Indeed, one implementation is to supply the game code for a game on an EPROM such that it can be “plugged” into the gaming platform.

It is also possible for the operative components of the gaming machine 100 to be distributed, for example input/output devices 106,107,108,109,110,111 to be provided remotely from the game controller 101.

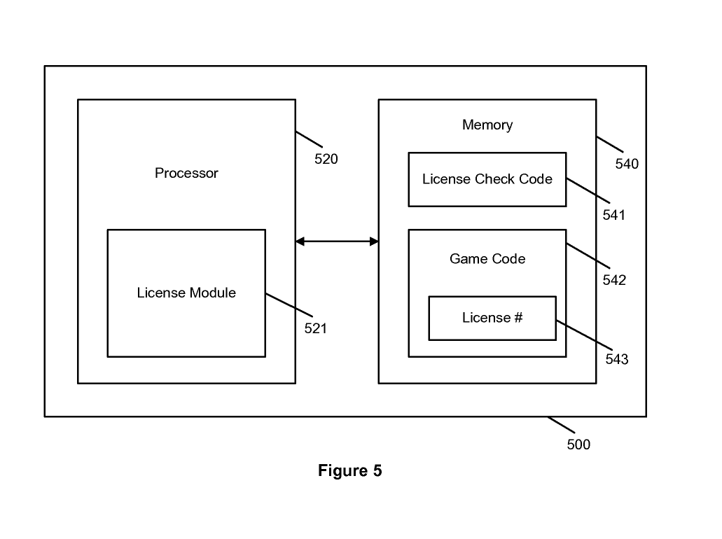

In an embodiment, a gaming device of the type described above can be configured to perform its own check to determine whether the license is current. An exemplary block diagram of such an embodiment is shown in FIG. 5 where the gaming device 500 has a processor 520 arranged to implement the gaming platform and a game based on programs stored in a memory 540. Memory 540 includes license check code 541 which causes the processor 520 to implement a license module 521. For example during a boot process. The license module 521 is arranged to check the game code 542 to determine whether it includes within it license data 543 which shows that the license is current. Thus in this embodiment, the method involves checking whether the license is a continual license and if it is allowing the game code to execute. If the license is a fixed license, the method involves checking whether the term is expired. Alternatively, there can be recorded against the game code or elsewhere in the memory 540 the end date of the license and the end date of all licenses can be checked. In this case an end date a long time in the future, for example 100 years, can be used for a continual license. In the above example, there is a requirement for the license details to be distributed with the game code to the gaming machine.

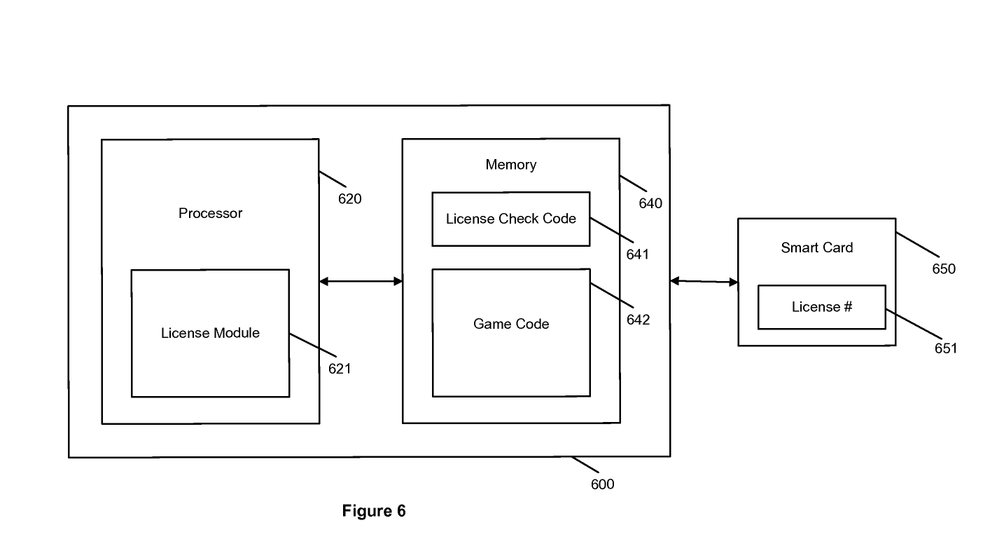

FIG. 6 shows an alternative arrangement where a gaming device main board 600 has a processor 620 and a memory 640. Again the processor implements a license module 620 based on license check code 641 stored in the memory 640 and is able to implement the game based on game code 642. In this embodiment, the license module checks license details 651 stored on a smart card 650 connected to the main board 600. In this way, the license can be distributed on a smart card or other dongle to control use of the games.

It will be understood to persons skilled in the art of the invention that many modifications may be made without departing from the spirit and scope of the invention, in particular it will be apparent that certain features of embodiments of the invention can be employed to form further embodiments.

It is to be understood that, if any prior art is referred to herein, such reference does not constitute an admission that the prior art forms a part of the common general knowledge in the art in any country.

In the claims which follow and in the preceding description of certain embodiments of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. Several embodiments are described above with reference to the drawings. These drawings illustrate certain details of specific embodiments that implement the systems and methods and programs of the present invention. However, describing the invention with drawings should not be construed as imposing on the invention any limitations associated with features shown in the drawings. It will be understood that the invention disclosed and defined in this specification extends to all alternative combinations of two or more of the individual features mentioned or evident from the text or drawings. All of these different combinations constitute various alternative aspects of the invention.

The present invention contemplates methods, systems and program products on any electronic device and/or machine-readable media suitable for accomplishing its operations. Certain embodiments of the present invention may be implemented using an existing computer processor and/or by a special purpose computer processor incorporated for this or another purpose or by a hardwired system, for example.

Embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

1. A transaction method comprising:
selling for a first value, a game to be implemented by a gaming device; and
selling for a second value, a license to use the game on a gaming device.

2. A transaction method as claimed in claim 1, comprising selling the game by selling a game kit comprising game code and media bearing artwork to be applied to the gaming device.

3. A transaction method as claimed in claim 2, comprising providing the game code on a memory device.

4. A transaction method as claimed in claim 3 wherein the memory device is an EPROM.

5. A transaction method as claimed in claim 1, wherein the license is a continual term license which entitles the licensee to use the game for an unlimited time but precludes the licensee from purchasing and associating a replacement game with the license.

6. A transaction method as claimed in claim 1, wherein the licensee is entitled to associate a replacement game with the license if the replacement game is provided under a warranty.

7. A transaction method as claimed in claim 1, wherein the license is a fixed term license which entitles the licensee to use the game for a fixed time and allows the licensee to associate a purchased replacement game with the license.

8. A transaction method as claimed in claim 7, further comprising selling at least one replacement game for a third value.

9. A transaction method as claimed in claim 8, wherein a base value of the third value is the same as a base value of the first value.

10. A transaction method as claimed in claim 1, further comprising:
offering a choice between
a continual term license which entitles the licensee to use the game for an unlimited time but precludes the licensee from purchasing and associating a replacement game with the license, and
a fixed term license which entitles the licensee to use the game for a fixed time and allows the licensee to associate a purchased replacement game with the license; and
receiving a selection of one a continual term license and a fixed term license,
and wherein selling a license comprises selling the selected license.

11. A transaction method as claimed in claim 10, comprising offering a loyalty discount based on the percentage of the total number of gaming devices that are subject of a fixed license.

12. A transaction method as claimed in claim 11, wherein the total number of gaming devices is derived from at least one of a total number of gaming devices owned by the purchaser and a total number of gaming devices deployed at a venue controlled by the purchaser.

13. A method of controlling use of at least one game, the method comprising:
selling for a first value, a game to be implemented by a gaming device;
selling for a second value, a license to use the game on a gaming device, the license having a term; and
permitting the game to be used on a gaming device while the term is current.

14. A method as claimed in claim 13, further comprising:
offering a choice between
a continual term license which entitles the licensee to use the game for an unlimited time but precludes the licensee from purchasing and associating a replacement game with the license, and
a fixed term license which entitles the licensee to use the game for a fixed time and allows the licensee to associate a purchased replacement game with the license; and
receiving a selection of one of a continual term license and a fixed term license,
and wherein selling a license comprises selling the selected license.

15. A method as claimed in claim 14 comprising determining prior to allowing the program code of the game to execute whether the license is a fixed term license or a continual term license, and, if the license is a fixed term license, checking whether the license is current before allowing the program code to execute.

16. A method as claimed in claim 14, comprising preventing the game from being used after the term of a fixed term license.

17. A method as claimed in claim 14 comprising making a record in a data structure of the license and the game with which it is associated.

18. A method as claimed in claim 14, further comprising:
receiving a request from a licensee of the license to associate a further game purchased by the licensee with the license during the term of the license; and
denying the request if the license is a continual term license; or
allowing the request if the license is a fixed term license.

19. A method as claimed in claim 18 comprising making a record in a data structure of the license and the game with which it is associated and checking the data structure in response to receipt of the request.

20. A method of licensing a plurality of games, comprising:
issuing a fixed term license to a licensee;
associating the fixed term license with a first game purchased by the licensee such that the first game can be used on a gaming device; and
transferring the issued fixed term license to a second game purchased by the licensee such that the second game can be used on the gaming device.

21. A method as claimed in claim 20 comprising allowing the licensee to successively associate as many games as desired with the fixed term license during the term of the fixed term license.

22. A method as claimed in claim 20 comprising recording the association in a data structure, periodically checking the data structure to determine whether the fixed term license is still current or has expired.

23. A method as claimed in claim 20 comprising preventing further use of a game currently associated with the fixed term license when the fixed term license is determined to have expired.

24. A method of controlling use of a game by a gaming device, the game having an associated license, the method comprising determining prior to allowing the program code of the game to execute whether the license is a fixed term license or a continual term license, and, if the license is a fixed term license, checking whether the license is current before allowing the program code to execute.

25. A method as claimed in claim 24 comprising checking a record in a data structure to determine whether the license is current.

26. A method as claimed in claim 25, wherein the checking is performed by a license module of a gaming device and comprises checking whether a dongle connected to the gaming device which stores the data structure has a record in the data structure indicative that the license is current.

27. A method as claimed in claim 25, wherein the checking is performed by a license module of a gaming device and comprises checking a data structure in data communication with the gaming device over a network to determine whether the data structure has a record indicative that the license is current.

28. A gaming device comprising a license module, the license module arranged to determine, prior to allowing execution of program code of a game having an associated license, whether the license is a fixed term license or a continual term license, and, if the license is a fixed term license, check that the license is current before allowing the program code to execute.

29. A gaming device as claimed in claim 28, wherein the license module checks whether a dongle connected to the gaming device which stores a data structure has a record in the data structure indicative that the license is current.

30. A gaming system comprising:
a communication network;
a data structure storing records indicative of whether a game has an associated license, whether each license is a continual license or a fixed term license, and when a term of each fixed term license expires; and
at least one gaming device connected to the data structure via the communication network, and arranged to determine by checking the data structure, prior to allowing execution of program code of a game having an associated license, whether the license is a fixed term license or a continual term license, and, if the license is a fixed term license, that the license is current before allowing the program code to execute.

31. A tangible computer readable medium comprising computer program code for execution by a processing system, the computer program code, when executed, implements a method of controlling use of a game by a gaming device, the game having an associated license, the method comprising determining prior to allowing the program code of the game to execute whether the license is a fixed term license or a continual term license, and, if the license is a fixed term license, checking whether the license is current before allowing the program code to execute.
